(19) United States
(12) Patent Application Publication
(10) Pub. No.: US 2025/0342164 A1
(43) Pub. Date: Nov. 6, 2025

(54) COMPUTING TABLE-LEVEL TIMESTAMPS USING MULTIPLE KEY RANGES

(71) Applicant: Rubrik, Inc., Palo Alto, CA (US)

(72) Inventors: Shubham Jadhav, Bengaluru (IN); Mohan Raghu Garimella, Bengaluru (IN); Shubham Tagra, Bengaluru (IN)

(21) Appl. No.: 18/656,204

(22) Filed: May 6, 2024

(51) Int. Cl. G06F 16/2458; G06F 16/22

(52) U.S. Cl. CPC G06F 16/2477; G06F 16/2246

(57) ABSTRACT

Methods, systems, and devices for data management are described. The described techniques may enable a data management system (DMS) to determine table-level timestamps based on checkpoints associated with multiple ranges of a table. For example, the DMS may identify a set of all key ranges associated with the table and a corresponding set of timestamps associated with the set of key ranges. The DMS may identify a subset of the set of key ranges including one or more ranges with a subset of timestamps that are latest in time of the set of timestamps. The subset of key ranges may include a full key span of the table. In some examples, a temporally earliest timestamp of the subset of timestamps may be indicative of a table-level timestamp, and the DMS may accordingly determine if the table is up-to-date based on the table-level timestamp.

### FIELD OF TECHNOLOGY

The present disclosure relates generally to data management, including techniques for computing table-level timestamps using multiple key ranges.

### BACKGROUND

A data management system (DMS) may be employed to manage data associated with one or more computing systems. The data may be generated, stored, or otherwise used by the one or more computing systems, examples of which may include servers, databases, virtual machines, cloud computing systems, file systems (e.g., network-attached storage (NAS) systems), or other data storage or processing systems. The DMS may provide data backup, data recovery, data classification, or other types of data management services for data of the one or more computing systems. Improved data management may offer improved performance with respect to reliability, speed, efficiency, scalability, security, or ease-of-use, among other possible aspects of performance.

### BRIEF DESCRIPTION OF THE DRAWINGS

FIG. 1 illustrates an example of a computing environment that supports computing table-level timestamps using multiple key ranges in accordance with aspects of the present disclosure.

FIG. 2 shows an example of a key range diagram that supports computing table-level timestamps using multiple key ranges in accordance with aspects of the present disclosure.

FIG. 3 shows an example of a block diagram that supports computing table-level timestamps using multiple key ranges in accordance with aspects of the present disclosure.

FIG. 4 shows a block diagram of an apparatus that supports computing table-level timestamps using multiple key ranges in accordance with aspects of the present disclosure.

FIG. 5 shows a block diagram of a data storage environment that supports computing table-level timestamps using multiple key ranges in accordance with aspects of the present disclosure.

FIG. 6 shows a diagram of a system including a device that supports computing table-level timestamps using multiple key ranges in accordance with aspects of the present disclosure.

FIGS. 7 through 9 show flowcharts illustrating methods that support computing table-level timestamps using multiple key ranges in accordance with aspects of the present disclosure.

### DETAILED DESCRIPTION

A data management system (DMS) may include a distributed system (e.g., with multiple distributed nodes or clusters of nodes) to support performing data backup for databases. Such data backup often includes running applications across multiple data centers and cloud environments. The metadata of such applications may be stored at a source data storage environment. A destination data storage environment may access metadata of applications running in a different source data storage environment. To access the metadata, the destination data storage environment may cache metadata of an application running in a different environment locally using a push-based caching method where every data center pushes the changes to the application as the changes take place. The destination data storage environment may track checkpoints (e.g., timestamps) associated with portions (e.g., ranges) of the metadata to determine if a source data storage environment is backlogged. For example, the destination data storage environment may determine that the source data storage environment is backlogged if a checkpoint of a range is older than a threshold. However, a table associated with the metadata (e.g., a table including one or more keys) may include multiple ranges (e.g., key ranges) which may be stored across multiple nodes, and each node may produce checkpoints independently. Accordingly, a checkpoint associated with a given range may not be indicative of whether the table as a whole is up-to-date.

Accordingly, techniques described herein may enable a DMS to determine table-level timestamps (e.g., checkpoints) based on checkpoints associated with multiple ranges of the table. The DMS may therefore determine whether a table is up-to-date or whether one or more source data storage environments are backlogged. For example, the DMS may identify a set of all key ranges associated with the table and a corresponding set of checkpoints associated with the set of key ranges. The DMS may identify a subset of the set of key ranges including one or more ranges with a subset of checkpoints that are latest in time of the set of checkpoints. The subset of key ranges may include a full key span of the table (e.g., from a starting key to an ending key of the table). In some examples, an earliest checkpoint of the subset of checkpoints may be indicative of a table-level checkpoint. Accordingly, the DMS may determine that a source data storage environment associated with the table is backlogged if the earliest checkpoint of the subset of checkpoints is older than the threshold amount, and thus that the table as a whole is not up-to-date.

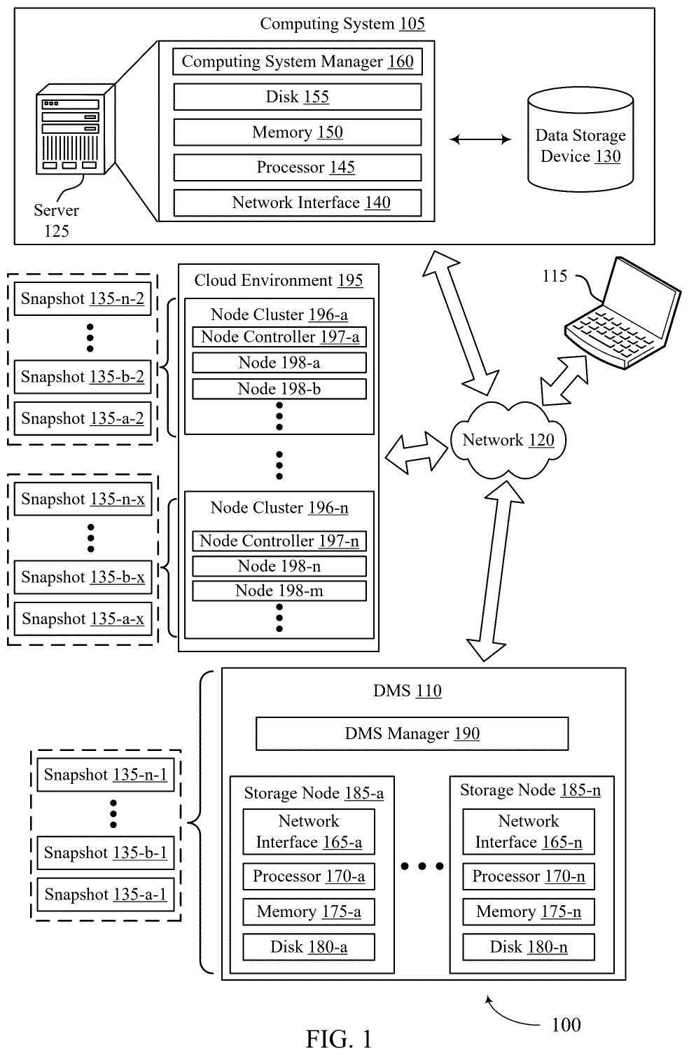

FIG. 1 illustrates an example of a computing environment 100 that supports computing table-level timestamps using multiple key ranges in accordance with aspects of the present disclosure. The computing environment 100 may include a computing system 105, a DMS 110, and one or more computing devices 115, which may be in communication with one another via a network 120. The computing system 105 may generate, store, process, modify, or otherwise use associated data, and the DMS 110 may provide one or more data management services for the computing system 105. For example, the DMS 110 may provide a data backup service, a data recovery service, a data classification service, a data transfer or replication service, one or more other data management services, or any combination thereof for data associated with the computing system 105.

The network 120 may allow the one or more computing devices 115, the computing system 105, and the DMS 110 to communicate (e.g., exchange information) with one another. The network 120 may include aspects of one or more wired networks (e.g., the Internet), one or more wireless networks (e.g., cellular networks), or any combination thereof. The network 120 may include aspects of one or more public networks or private networks, as well as secured or unsecured networks, or any combination thereof. The network 120 also may include any quantity of communications links and any quantity of hubs, bridges, routers, switches, ports or other physical or logical network components.

A computing device 115 may be used to input information to or receive information from the computing system 105, the DMS 110, or both. For example, a user of the computing device 115 may provide user inputs via the computing device 115, which may result in commands, data, or any combination thereof being communicated via the network 120 to the computing system 105, the DMS 110, or both. Additionally, or alternatively, a computing device 115 may output (e.g., display) data or other information received from the computing system 105, the DMS 110, or both. A user of a computing device 115 may, for example, use the computing device 115 to interact with one or more user interfaces (e.g., graphical user interfaces (GUIs)) to operate or otherwise interact with the computing system 105, the DMS 110, or both. Though one computing device 115 is shown in FIG. 1, it is to be understood that the computing environment 100 may include any quantity of computing devices 115.

A computing device 115 may be a stationary device (e.g., a desktop computer or access point) or a mobile device (e.g., a laptop computer, tablet computer, or cellular phone). In some examples, a computing device 115 may be a commercial computing device, such as a server or collection of servers. And in some examples, a computing device 115 may be a virtual device (e.g., a virtual machine). Though shown as a separate device in the example computing environment of FIG. 1, it is to be understood that in some cases a computing device 115 may be included in (e.g., may be a component of) the computing system 105 or the DMS 110.

The computing system 105 may include one or more servers 125 and may provide (e.g., to the one or more computing devices 115) local or remote access to applications, databases, or files stored within the computing system 105. The computing system 105 may further include one or more data storage devices 130. Though one server 125 and one data storage device 130 are shown in FIG. 1, it is to be understood that the computing system 105 may include any quantity of servers 125 and any quantity of data storage devices 130, which may be in communication with one another and collectively perform one or more functions ascribed herein to the server 125 and data storage device 130.

A data storage device 130 may include one or more hardware storage devices operable to store data, such as one or more hard disk drives (HDDs), magnetic tape drives, solid-state drives (SSDs), storage area network (SAN) storage devices, or network-attached storage (NAS) devices. In some cases, a data storage device 130 may comprise a tiered data storage infrastructure (or a portion of a tiered data storage infrastructure). A tiered data storage infrastructure may allow for the movement of data across different tiers of the data storage infrastructure between higher-cost, higher-performance storage devices (e.g., SSDs and HDDs) and relatively lower-cost, lower-performance storage devices (e.g., magnetic tape drives). In some examples, a data storage device 130 may be a database (e.g., a relational database), and a server 125 may host (e.g., provide a database management system for) the database.

A server 125 may allow a client (e.g., a computing device 115) to download information or files (e.g., executable, text, application, audio, image, or video files) from the computing system 105, to upload such information or files to the computing system 105, or to perform a search query related to particular information stored by the computing system 105. In some examples, a server 125 may act as an application server or a file server. In general, a server 125 may refer to one or more hardware devices that act as the host in a client-server relationship or a software process that shares a resource with or performs work for one or more clients.

A server 125 may include a network interface 140, processor 145, memory 150, disk 155, and computing system manager 160. The network interface 140 may enable the server 125 to connect to and exchange information via the network 120 (e.g., using one or more network protocols). The network interface 140 may include one or more wireless network interfaces, one or more wired network interfaces, or any combination thereof. The processor 145 may execute computer-readable instructions stored in the memory 150 in order to cause the server 125 to perform functions ascribed herein to the server 125. The processor 145 may include one or more processing units, such as one or more central processing units (CPUs), one or more graphics processing units (GPUs), or any combination thereof. The memory 150 may comprise one or more types of memory (e.g., random access memory (RAM), static random access memory (SRAM), dynamic random access memory (DRAM), read-only memory (ROM), electrically erasable programmable read-only memory (EEPROM), Flash, etc.). Disk 155 may include one or more HDDs, one or more SSDs, or any combination thereof. Memory 150 and disk 155 may comprise hardware storage devices. The computing system manager 160 may manage the computing system 105 or aspects thereof (e.g., based on instructions stored in the memory 150 and executed by the processor 145) to perform functions ascribed herein to the computing system 105. In some examples, the network interface 140, processor 145, memory 150, and disk 155 may be included in a hardware layer of a server 125, and the computing system manager 160 may be included in a software layer of the server 125. In some cases, the computing system manager 160 may be distributed across (e.g., implemented by) multiple servers 125 within the computing system 105.

In some examples, the computing system 105 or aspects thereof may be implemented within one or more cloud computing environments, which may alternatively be referred to as cloud environments. Cloud computing may refer to Internet-based computing, wherein shared resources, software, and/or information may be provided to one or more computing devices on-demand via the Internet. A cloud environment may be provided by a cloud platform, where the cloud platform may include physical hardware components (e.g., servers) and software components (e.g., operating system) that implement the cloud environment. A cloud environment may implement the computing system 105 or aspects thereof through Software-as-a-Service (SaaS) or Infrastructure-as-a-Service (IaaS) services provided by the cloud environment. SaaS may refer to a software distribution model in which applications are hosted by a service provider and made available to one or more client devices over a network (e.g., to one or more computing devices 115 over the network 120). IaaS may refer to a service in which physical computing resources are used to instantiate one or more virtual machines, the resources of which are made available to one or more client devices over a network (e.g., to one or more computing devices 115 over the network 120).

In some examples, the computing system 105 or aspects thereof may implement or be implemented by one or more virtual machines. The one or more virtual machines may run various applications, such as a database server, an application server, or a web server. For example, a server 125 may be used to host (e.g., create, manage) one or more virtual machines, and the computing system manager 160 may manage a virtualized infrastructure within the computing system 105 and perform management operations associated with the virtualized infrastructure. The computing system manager 160 may manage the provisioning of virtual machines running within the virtualized infrastructure and provide an interface to a computing device 115 interacting with the virtualized infrastructure. For example, the computing system manager 160 may be or include a hypervisor and may perform various virtual machine-related tasks, such as cloning virtual machines, creating new virtual machines, monitoring the state of virtual machines, moving virtual machines between physical hosts for load balancing purposes, and facilitating backups of virtual machines. In some examples, the virtual machines, the hypervisor, or both, may virtualize and make available resources of the disk 155, the memory, the processor 145, the network interface 140, the data storage device 130, or any combination thereof in support of running the various applications. Storage resources (e.g., the disk 155, the memory 150, or the data storage device 130) that are virtualized may be accessed by applications as a virtual disk.

The DMS 110 may provide one or more data management services for data associated with the computing system 105 and may include DMS manager 190 and any quantity of storage nodes 185. The DMS manager 190 may manage operation of the DMS 110, including the storage nodes 185. Though illustrated as a separate entity within the DMS 110, the DMS manager 190 may in some cases be implemented (e.g., as a software application) by one or more of the storage nodes 185. In some examples, the storage nodes 185 may be included in a hardware layer of the DMS 110, and the DMS manager 190 may be included in a software layer of the DMS 110. In the example illustrated in FIG. 1, the DMS 110 is separate from the computing system 105 but in communication with the computing system 105 via the network 120. It is to be understood, however, that in some examples at least some aspects of the DMS 110 may be located within computing system 105. For example, one or more servers 125, one or more data storage devices 130, and at least some aspects of the DMS 110 may be implemented within the same cloud environment or within the same data center.

Storage nodes 185 (e.g., a storage node 185-a through a storage node 185-n) of the DMS 110 may include respective network interfaces 165 (e.g., a network interface 165-a through a network interface 165-n), processors 170 (e.g., a processor 170-a through a processor 170-n), memories 175 (e.g., a memory 175-a through a memory 175-n), and disks 180 (e.g., a disc 180-a through a disc 180-n). The network interfaces 165 may enable the storage nodes 185 to connect to one another, to the network 120, or both. A network interface 165 may include one or more wireless network interfaces, one or more wired network interfaces, or any combination thereof. The processor 170 of a storage node 185 may execute computer-readable instructions stored in the memory 175 of the storage node 185 in order to cause the storage node 185 to perform processes described herein as performed by the storage node 185. A processor 170 may include one or more processing units, such as one or more CPUs, one or more GPUs, or any combination thereof. The memory 150 may comprise one or more types of memory (e.g., RAM, SRAM, DRAM, ROM, EEPROM, Flash, etc.). A disk 180 may include one or more HDDs, one or more SDDs, or any combination thereof. Memories 175 and disks 180 may comprise hardware storage devices. Collectively, the storage nodes 185 may in some cases be referred to as a storage cluster or as a cluster of storage nodes 185.

The DMS 110 may provide a backup and recovery service for the computing system 105. For example, the DMS 110 may manage the extraction and storage of snapshots 135 associated with different point-in-time versions of one or more target computing objects within the computing system 105. A snapshot 135 of a computing object (e.g., a virtual machine, a database, a filesystem, a virtual disk, a virtual desktop, or other type of computing system or storage system) may be a file (or set of files) that represents a state of the computing object (e.g., the data thereof) as of a particular point in time. A snapshot 135 may also be used to restore (e.g., recover) the corresponding computing object as of the particular point in time corresponding to the snapshot 135. A computing object of which a snapshot 135 may be generated may be referred to as snappable. Snapshots 135 may be generated at different times (e.g., periodically or on some other scheduled or configured basis) in order to represent the state of the computing system 105 or aspects thereof as of those different times. In some examples, a snapshot 135 may include metadata that defines a state of the computing object as of a particular point in time. For example, a snapshot 135 may include metadata associated with (e.g., that defines a state of) some or all data blocks included in (e.g., stored by or otherwise included in) the computing object. Snapshots 135 (e.g., collectively) may capture changes in the data blocks over time. Snapshots 135 generated for the target computing objects within the computing system 105 may be stored in one or more storage locations (e.g., the disk 155, memory 150, the data storage device 130) of the computing system 105, in the alternative or in addition to being stored within the DMS 110, as described below.

To obtain a snapshot 135 of a target computing object associated with the computing system 105 (e.g., of the entirety of the computing system 105 or some portion thereof, such as one or more databases, virtual machines, or filesystems within the computing system 105), the DMS manager 190 may transmit a snapshot request to the computing system manager 160. In response to the snapshot request, the computing system manager 160 may set the target computing object into a frozen state (e.g., a read-only state). Setting the target computing object into a frozen state may allow a point-in-time snapshot 135 of the target computing object to be stored or transferred.

In some examples, the computing system 105 may generate the snapshot 135 based on the frozen state of the computing object. For example, the computing system 105 may execute an agent of the DMS 110 (e.g., the agent may be software installed at and executed by one or more servers 125), and the agent may cause the computing system 105 to generate the snapshot 135 and transfer the snapshot 135 to the DMS 110 in response to the request from the DMS 110. In some examples, the computing system manager 160 may cause the computing system 105 to transfer, to the DMS 110, data that represents the frozen state of the target computing object, and the DMS 110 may generate a snapshot 135 of the target computing object based on the corresponding data received from the computing system 105.

Once the DMS 110 receives, generates, or otherwise obtains a snapshot 135, the DMS 110 may store the snapshot 135 at one or more of the storage nodes 185. The DMS 110 may store a snapshot 135 at multiple storage nodes 185, for example, for improved reliability. Additionally, or alternatively, snapshots 135 may be stored in some other location connected with the network 120. For example, the DMS 110 may store more recent snapshots 135 at the storage nodes 185, and the DMS 110 may transfer less recent snapshots 135 via the network 120 to a cloud environment (which may include or be separate from the computing system 105) for storage at the cloud environment, a magnetic tape storage device, or another storage system separate from the DMS 110.

Updates made to a target computing object that has been set into a frozen state may be written by the computing system 105 to a separate file (e.g., an update file) or other entity within the computing system 105 while the target computing object is in the frozen state. After the snapshot 135 (or associated data) of the target computing object has been transferred to the DMS 110, the computing system manager 160 may release the target computing object from the frozen state, and any corresponding updates written to the separate file or other entity may be merged into the target computing object.

In response to a restore command (e.g., from a computing device 115 or the computing system 105), the DMS 110 may restore a target version (e.g., corresponding to a particular point in time) of a computing object based on a corresponding snapshot 135 of the computing object. In some examples, the corresponding snapshot 135 may be used to restore the target version based on data of the computing object as stored at the computing system 105 (e.g., based on information included in the corresponding snapshot 135 and other information stored at the computing system 105, the computing object may be restored to its state as of the particular point in time). Additionally, or alternatively, the corresponding snapshot 135 may be used to restore the data of the target version based on data of the computing object as included in one or more backup copies of the computing object (e.g., file-level backup copies or image-level backup copies). Such backup copies of the computing object may be generated in conjunction with or according to a separate schedule than the snapshots 135. For example, the target version of the computing object may be restored based on the information in a snapshot 135 and based on information included in a backup copy of the target object generated prior to the time corresponding to the target version. Backup copies of the computing object may be stored at the DMS 110 (e.g., in the storage nodes 185) or in some other location connected with the network 120 (e.g., in a cloud environment, which in some cases may be separate from the computing system 105).

In some examples, the DMS 110 may restore the target version of the computing object and transfer the data of the restored computing object to the computing system 105. And in some examples, the DMS 110 may transfer one or more snapshots 135 to the computing system 105, and restoration of the target version of the computing object may occur at the computing system 105 (e.g., as managed by an agent of the DMS 110, where the agent may be installed and operate at the computing system 105).

In response to a mount command (e.g., from a computing device 115 or the computing system 105), the DMS 110 may instantiate data associated with a point-in-time version of a computing object based on a snapshot 135 corresponding to the computing object (e.g., along with data included in a backup copy of the computing object) and the point-in-time. The DMS 110 may then allow the computing system 105 to read or modify the instantiated data (e.g., without transferring the instantiated data to the computing system). In some examples, the DMS 110 may instantiate (e.g., virtually mount) some or all of the data associated with the point-in-time version of the computing object for access by the computing system 105, the DMS 110, or the computing device 115.

In some examples, the DMS 110 may store different types of snapshots 135, including for the same computing object. For example, the DMS 110 may store both base snapshots 135 and incremental snapshots 135. A base snapshot 135 may represent the entirety of the state of the corresponding computing object as of a point in time corresponding to the base snapshot 135. An incremental snapshot 135 may represent the changes to the state—which may be referred to as the delta—of the corresponding computing object that have occurred between an earlier or later point in time corresponding to another snapshot 135 (e.g., another base snapshot 135 or incremental snapshot 135) of the computing object and the incremental snapshot 135. In some cases, some incremental snapshots 135 may be forward-incremental snapshots 135 and other incremental snapshots 135 may be reverse-incremental snapshots 135. To generate a full snapshot 135 of a computing object using a forward-incremental snapshot 135, the information of the forward-incremental snapshot 135 may be combined with (e.g., applied to) the information of an earlier base snapshot 135 of the computing object along with the information of any intervening forward-incremental snapshots 135, where the earlier base snapshot 135 may include a base snapshot 135 and one or more reverse-incremental or forward-incremental snapshots 135. To generate a full snapshot 135 of a computing object using a reverse-incremental snapshot 135, the information of the reverse-incremental snapshot 135 may be combined with (e.g., applied to) the information of a later base snapshot 135 of the computing object along with the information of any intervening reverse-incremental snapshots 135.

In some examples, the DMS 110 may provide a data classification service, a malware detection service, a data transfer or replication service, backup verification service, or any combination thereof, among other possible data management services for data associated with the computing system 105. For example, the DMS 110 may analyze data included in one or more computing objects of the computing system 105, metadata for one or more computing objects of the computing system 105, or any combination thereof, and based on such analysis, the DMS 110 may identify locations within the computing system 105 that include data of one or more target data types (e.g., sensitive data, such as data subject to privacy regulations or otherwise of particular interest) and output related information (e.g., for display to a user via a computing device 115). Additionally, or alternatively, the DMS 110 may detect whether aspects of the computing system 105 have been impacted by malware (e.g., ransomware). Additionally, or alternatively, the DMS 110 may relocate data or create copies of data based on using one or more snapshots 135 to restore the associated computing object within its original location or at a new location (e.g., a new location within a different computing system 105). Additionally, or alternatively, the DMS 110 may analyze backup data to ensure that the underlying data (e.g., user data or metadata) has not been corrupted. The DMS 110 may perform such data classification, malware detection, data transfer or replication, or backup verification, for example, based on data included in snapshots 135 or backup copies of the computing system 105, rather than live contents of the computing system 105, which may beneficially avoid adversely affecting (e.g., infecting, loading, etc.) the computing system 105.

In some examples, the DMS 110, and in particular the DMS manager 190, may be referred to as a control plane. The control plane may manage tasks, such as storing data management data or performing restorations, among other possible examples. The control plane may be common to multiple customers or tenants of the DMS 110. For example, the computing system 105 may be associated with a first customer or tenant of the DMS 110, and the DMS 110 may similarly provide data management services for one or more other computing systems associated with one or more additional customers or tenants. In some examples, the control plane may be configured to manage the transfer of data management data (e.g., snapshots 135 associated with the computing system 105) to a cloud environment 195 (e.g., Microsoft Azure or Amazon Web Services). In addition, or as an alternative, to being configured to manage the transfer of data management data to the cloud environment 195, the control plane may be configured to transfer metadata for the data management data to the cloud environment 195. The metadata may be configured to facilitate storage of the stored data management data, the management of the stored management data, the processing of the stored management data, the restoration of the stored data management data, and the like.

Each customer or tenant of the DMS 110 may have a private data plane, where a data plane may include a location at which customer or tenant data is stored. For example, each private data plane for each customer or tenant may include a node cluster 196 across which data (e.g., data management data, metadata for data management data, etc.) for a customer or tenant is stored. Each node cluster 196 may include a node controller 197 which manages the nodes 198 of the node cluster 196. As an example, a node cluster 196 for one tenant or customer may be hosted on Microsoft Azure, and another node cluster 196 may be hosted on Amazon Web Services. In another example, multiple separate node clusters 196 for multiple different customers or tenants may be hosted on Microsoft Azure. Separating each customer or tenant's data into separate node clusters 196 provides fault isolation for the different customers or tenants and provides security by limiting access to data for each customer or tenant.

The control plane (e.g., the DMS 110, and specifically the DMS manager 190) manages tasks, such as storing backups or snapshots 135 or performing restorations, across the multiple node clusters 196. For example, as described herein, a node cluster 196-a may be associated with the first customer or tenant associated with the computing system 105. The DMS 110 may obtain (e.g., generate or receive) and transfer the snapshots 135 associated with the computing system 105 to the node cluster 196-a in accordance with a service level agreement for the first customer or tenant associated with the computing system 105. For example, a service level agreement may define backup and recovery parameters for a customer or tenant such as snapshot generation frequency, which computing objects to backup, where to store the snapshots 135 (e.g., which private data plane), and how long to retain snapshots 135. As described herein, the control plane may provide data management services for another computing system associated with another customer or tenant. For example, the control plane may generate and transfer snapshots 135 for another computing system associated with another customer or tenant to the node cluster 196-n in accordance with the service level agreement for the other customer or tenant.

To manage tasks, such as storing backups or snapshots 135 or performing restorations, across the multiple node clusters 196, the control plane (e.g., the DMS manager 190) may communicate with the node controllers 197 for the various node clusters via the network 120. For example, the control plane may exchange communications for backup and recovery tasks with the node controllers 197 in the form of transmission control protocol (TCP) packets via the network 120.

Techniques described herein may enable a DMS 110 to determine table-level timestamps (e.g., checkpoints, heartbeats) based on checkpoints associated with multiple key ranges of a table that includes one or more keys of a keyspan (e.g., from a starting key to an ending key). In some examples, the multiple key ranges may be stored across multiple storage nodes 185, and each of the multiple key ranges may be associated with a respective timestamp. The DMS 110 may identify a set of all key ranges associated with the table and a corresponding set of checkpoints (e.g., timestamps) associated with the key ranges. The DMS 110 may identify a subset of the set of key ranges, each associated with a subset of the set of timestamps. The subset of key ranges may include at least one key range with a timestamp that is latest in time of the set of timestamps. The subset of key ranges may additionally include a full key span of the table (e.g., all keys from the starting key to the ending key of the table).

The DMS 110 may determine an earliest checkpoint of the subset of checkpoints. The earliest checkpoint of the subset of checkpoints may be indicative of a table-level checkpoint. Accordingly, the DMS 110 may determine that a source data storage environment (e.g., a storage node 185) associated with the table is backlogged if the earliest checkpoint of the subset of checkpoints is older than a threshold amount, and thus that the table as a whole is not up-to-date.

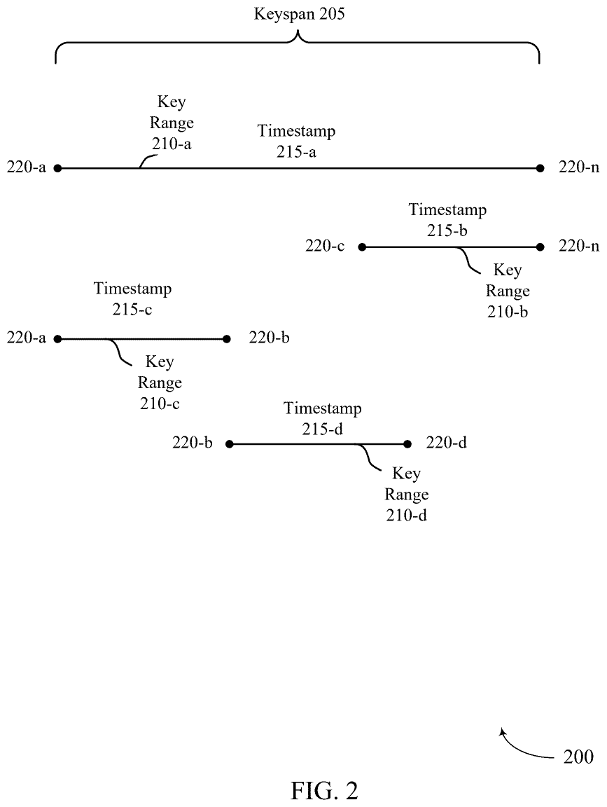

FIG. 2 shows an example of a key range diagram 200 that supports computing table-level timestamps using multiple key ranges in accordance with aspects of the present disclosure. The key range diagram 200 may implement or may be implemented by aspects of the computing environment 100. For example, the key range diagram 200 may be implemented by a DMS 110, which may be an example of the corresponding device as described with reference to the computing environment 100.

In some examples, a DMS 110 may use a push-based caching method, where metadata is periodically pushed from a source data storage environment (e.g., a storage node) to a destination data storage environment. With the push-based caching method, the DMS 110 may synchronize metadata across applications running in different data centers or cloud environments. In the example of a caching method, a single destination data storage environment may support multiple source data storage environments (e.g., storage nodes). The source data storage environments may track (e.g., synchronize) any insert/update/delete operations on a data table (e.g., a table including one or more keys in a keyspan 205, from a starting key 220-a to an ending key 220-b). The data table may have a fixed keyspan 205 such that all rows in the data table may be associated with a unique key 220 in the keyspan 205. In some examples, each source data storage environment may individually push updates for (e.g., replicate and manage) a respective key range 210 of a set of key ranges 210 comprising the data table (e.g., a subset of keys in the keyspan). The set of key ranges 210 may cover the full keyspan 205 of the data table (e.g., without any overlaps at a given point in time).

In some examples, the set of key ranges 210 may be volatile. That is, a key range 210 may split into multiple key ranges 210, or may merge with another key range 210 to form a single key range 210. For example, if a key range 210 exceeds a size threshold (e.g., a maximum size) or if a query-per-second (QPS) rate for one or more rows in a key range 210 is relatively high (e.g., above a threshold rate), the key range 210 may be split for load balancing. As an illustrative example, a range [a, z) may be split into two ranges [a, f) and [f, z). Conversely, a range [a, k) and a range [k, r) may be merged to form a range [a, r). Accordingly, the data table may be composed of different ranges at different instances in time. As described herein, a square bracket may be indicative of a range including the endpoint and a round bracket may be indicative of the range excluding the endpoint.

In some examples, the DMS 110 may determine whether any source data storage environment is lagging in pushing updates. For example, the DMS 110 may implement range-level timestamps 215 (e.g., checkpoints) to determine whether any source data storage environment is lagging in pushing updates for the respective key range 210. For example, a change data capture publisher may send a timestamp 215 for a key range indicating that all data up to a point in time (e.g., the timestamp 215) has been sent from the respective source data storage environment to the destination data storage environment for that key range 210. In some examples, the destination data storage environment may keep track of all the timestamps 215 consumed for a source data storage environment. If the latest timestamp 215 is older than some threshold (e.g., 5 minutes), the DMS 110 may infer that the source data storage environment is backlogged. Additionally, or alternatively, if the DMS 110 detects a backlog at the source data storage environment, then the DMS 110 may trigger a replay to recover from the backlog. Accordingly, timestamps 215 may enable the DMS 110 to determine that all updates for keys 220 in a respective key range 210 from a time up to the respective timestamp 215 are delivered to the client.

In some examples, however, multiple key ranges 210 of the data table may be stored (e.g., scattered) across different storage nodes and may each be associated with a different timestamp 215 (e.g., due to each storage node replicating and managing key ranges 210 individually). For example, to implement liveness and consensus mechanisms for leader election, each key range 210 (e.g., representing a subset of the keyspan 205) may be replicated multiple times (e.g., five times) across a cluster autonomously such that each key range 210 is maintained by five storage nodes. In some examples, key ranges 210 may move across storage nodes. Thus, a given timestamp 215 may not be indicative of whether the data table as a whole is up-to-date. Further, the destination data storage environment may not be aware of the set of key ranges 210 composing the data table at a given instance in time (e.g., due to the volatile nature of the key ranges 210). For example, the DMS 110 may identify one or more key ranges 210 (e.g., and associated timestamps 215) that were received at the destination data storage environment both pre- and post-merge/split.

Accordingly, one or more key ranges 210 identifiable by the DMS 110 may overlap and/or may have one or more holes (e.g., one or more keys 220 of the keyspan 205 that are not included in a given subset of key ranges 210). As an illustrative example, the destination data storage environment may identify a range [a, f) with a timestamp of 10, a range [a, c) with a timestamp of 20, and a range [c, d) with a timestamp of 40 (e.g., overlapping ranges). Additionally, or alternatively, the DMS 110 may identify a range [a, g) with a timestamp of 10 and a range [c, y) with a timestamp of 20 (e.g., missing ranges from [y, z)). Accordingly, although key ranges 210 in a given instant may not overlap, the DMS 110 may identify one or more key ranges 210 associated with different timestamps 215 that may overlap (e.g., or that may have holes).

Techniques described herein may enable a DMS 110 to amalgamate timestamp information at a data table level (e.g., to determine a table-level timestamp signifying the table's liveness based on the range-level timestamps 215). The DMS 110 may, additionally, or alternatively, identify missing ranges (e.g., holes) in a set of key ranges 210 (e.g., one or more keys that are not included in the set of key ranges 210), and may not generate timestamp information for the data table if a missing range is identified. For example, as described above, the DMS 110 may identify a range [a, g) with a timestamp of 10 and a range [c, y) with a timestamp of 20. Because the set of key ranges is missing keys from [y, z), the DMS 110 may not output a table-level timestamp using the identified ranges.

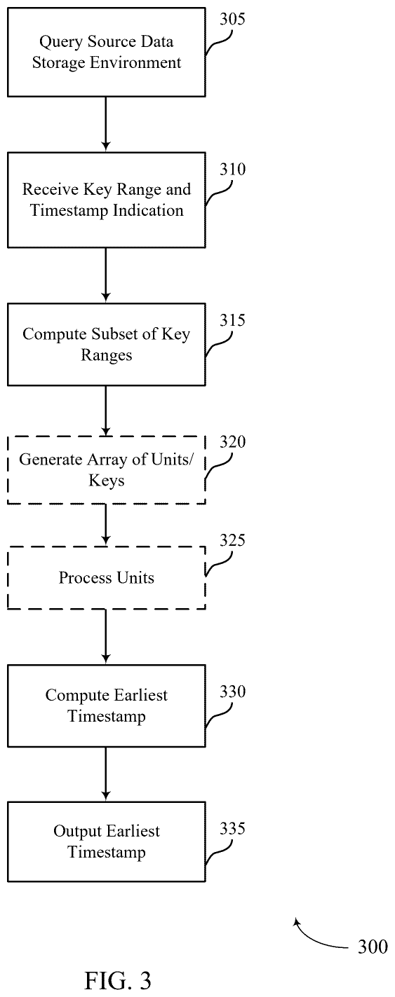

The DMS 110 may identify a set of key ranges (e.g., a key range 210-a, a key range 210-b, a key range 210-c, and a key range 210-d) of a data table for a keyspan 205 (e.g., a keyspan 205 from a key 220-a to a key 220-n). Each key range 210 may be associated with a respective set of timestamps (e.g., a timestamp 215-a, a timestamp 215-b, a timestamp 215-c, and a timestamp 215-d, respectively). The timestamp 215-a may be a lowest (e.g., temporally earliest) timestamp 215, and the timestamp 215-d may be a highest (e.g., temporally latest) timestamp 215. As illustrated with reference to FIG. 3, the key range 210-a may include keys 220 from a starting key 220-a to an ending key 220-n, the key range 210-b may include keys 220 from a starting key 220-c to an ending key 220-n, the key range 210-c may include keys 220 from a starting key 220-a to an ending key 220-b, and the key range 210-d may include keys 220 from a starting key 220-b to an ending key 220-d.

The DMS 110 may select a storage node for each key range 210 (e.g., one of five storage nodes having the data included in the key range 210) to maintain a local timeline for the key range 210 (e.g., a collection of checkpoints associated with the key range 210 at the selected storage node). In some examples, however, the selected storage node for maintaining the local timeline may change (e.g., due to ownership of key ranges 210 moving between storage nodes). Accordingly, a coordinator node may maintain a global timeline (e.g., a collection of checkpoints associated with the key range 210 from all associated storage nodes) for each data table. For example, key ranges 210 maintained across multiple storage nodes may be aggregated at the coordinator node. Based on the global timeline, the coordinator node may identify the key ranges 210 and the associated timestamps 215.

The coordinator node may verify that the keyspan 205 is covered by the identified set of key ranges 210 (e.g., may verify that the set of key ranges 210 does not include any holes). If a portion of the keyspan 205 is not covered by the identified set of key ranges 210, the coordinator node may not output a table-level timestamp 215. If a portion of the keyspan 205 is covered by the identified set of key ranges 210, the coordinator node may identify, for each respective key 220 of the keyspan 205 (e.g., from the key 220-a to the key 220-n), a key range 210 of the set of key ranges that includes the respective key 220 and that is associated with a highest (e.g., temporally latest, most recent) timestamp 215 of each key range 210. For example, as illustrated with reference to FIG. 3, the highest timestamp 215 of the key ranges 210 that include the key 220-b may be the timestamp 215-d. The coordinator node may determine a set of known keys by combining the start key 220 and the end key 220 of each known key range 210 for the data table (e.g., each range stored in global timelines).

A smallest (e.g., temporally earliest) timestamp 215 of all highest timestamps 215 for all keys 220 in the keyspan 205 may be the timestamp 215 of the data table. For example, as illustrated with reference to FIG. 3, the key range 210-b, the key range 210-c, and the key range 210-d may be the subset of key ranges 210 with the temporally latest timestamps 215 that include all keys 220 of the keyspan 205. The timestamp 215-b may be the temporally earliest timestamp 215 of the subset of timestamps 215 associated with the subset of key ranges, and therefore the timestamp 215-b may be the timestamp 215 of the table as a whole. Accordingly, the coordinator node may determine to output the timestamp 215-b as the table-level timestamp (e.g., without knowing an exhaustive list of keys 220 or key ranges 210 for the data table).

In some examples, to determine table-level timestamps 215 for a set of data tables, the coordinator node may identify the highest (e.g., temporally latest) timestamp 215 for a timeline of each key range 210 maintained by storage nodes of the DMS 110. The coordinator node may segregate identified ranges by which data table each range belongs to, and may check continuity and exhaustion of the key ranges 210 separately for each data table.

For each data table, the coordinator node may identify key limits of the keyspan 205 (e.g., the starting key 220-a and the ending key 220-n, from min(start_key) to max(end_key)). The keyspan 205 may include the key limits of all key ranges 210 associated with the data table. That is, all starting keys 220 and ending keys 220 of all key ranges 210 of the table may lie within the limits from min(start_key) to max(end_key). These limits may be referred to as the keyspace of the data table. In some examples, a keyspace associated with a given data table may not change (e.g., may be fixed). Accordingly, the coordinator node may fetch the key limits for a data table once.

In some examples, to identify continuity of key ranges 210 and to identify the table-level timestamp 215, the coordinator node may use a brute-force approach. For example, the coordinator node may create an array of all starting keys 220 and ending keys 220 of the set of key ranges 210 associated with a table. As illustrated with reference to FIG. 3, the array may include (220-a, 220-b, 220-c, 220-d, 220-n). The coordinator node may sort the array of keys 220 lexicographically (e.g., according to an order in which the keys 220 appear in the data table).

The coordinator node may identify a set of pseudo ranges (p-ranges) of the array. Each pseudo range may be a range from each key 220 in the array to the next consecutive key 220 in the array (e.g., forming a p-range [key[i], key[i+1])). Continuing with the above example, the set of p-ranges may include [220-a, 220-b), [220-b, 220-c), [220-c, 220-d), and [220-d, 220-n). Each p-range may be fully subsumed by one or more key range 210 of the set of key ranges 210 of the data table (e.g., because if p-range partially overlaps a key range 210 at a key 220, the key 220 may be present in the array of boundary keys). If a p-range is not covered by one or more key ranges 210 of the set of key ranges 210, the function may return an error indicating that there is a hole (e.g., the key ranges 210 do not cover all keys of the keyspan 205). The coordinator node may therefore not output a table-level timestamp 215.

The coordinator node may perform a function to check each p-range to find a maximum (e.g., temporally latest) timestamp 215 associated with a key range 210 that includes the respective p-range (e.g., the latest time at which any. For example, for the p-range [220-a, 220-b), the maximum timestamp 215 may be the timestamp 215-c. For the p-range [220-b, 220-c), the maximum timestamp 215 may be the timestamp 215-d. For the p-range [220-c, 220-d), the maximum timestamp 215 may be the timestamp 215-d. For the p-range [220-d, 220-n), the maximum timestamp 215 may be the timestamp 215-b. The coordinator node may track the minimum (e.g., temporally earliest) of the maximum timestamps 215 associated with each p-range. A complexity associated with such a brute force approach may be described as O(n log n)+O(n²), as all endpoint keys 220 (e.g., 2n keys, where n is a quantity of key ranges 210) are sorted and the coordinator node may iterate the function over each p-range.

Additionally, or alternatively, the coordinator node may use a red-black tree approach to determine the table-level timestamp 215, which may be relatively more optimized (e.g., faster) than the brute force approach. For example, the coordinator node may create an array of units from the key ranges 210. Each unit may include a key 220 (e.g., a point in the range 210), a flag indicating whether the key 220 is a starting key 220 or an ending key 220, and a timestamp 215 associated with the respective key range 210. The coordinator node may sort the array of units first based on a key 220, then based on whether the key 220 is the start of a range, and finally by the timestamp 215 of the unit.

The coordinator node may maintain a red-black tree of the units. The red-black tree may be initialized with a left-leaning red-black tree (LLRB) implementation to track current maximum timestamps 215 (e.g., a timestamp 215 that is a temporally latest timestamp for a given key 220). The coordinator node may maintain a variable (e.g., minTs) that may indicate a minimum (e.g., temporally earliest) timestamp 215 of the set of current maximum timestamps 215.

The coordinator node may use a function to process the units iteratively. For example, the coordinator node may check if the unit is the start or end of a key range 210. If the unit is the start of a key range 210, the function may check the timestamp 215 of the unit against the current maximum timestamp associated with the key 220, update the variable minTs, and insert the timestamp 215 into the tree. If the unit is the end of a key range 210, the function may check the timestamp 215 of the unit against the current maximum timestamp associated with the key 220, update the variable minTs, and remove the timestamp 215 from the tree. Accordingly, the tree may maintain timestamps 215 for the open key ranges 210 at any given key. The tree may output the variable minTs as the table-level timestamp 215.

If the tree is empty at any point, the coordinator node may identify that there is a hole in the keyspace (e.g., the key ranges 210 do not cover all keys of the keyspan 205). The coordinator node may therefore not output a table-level timestamp 215. The red-black tree approach may have a complexity of O(n log n) time complexity and O(n) space complexity.

FIG. 3 shows an example of a block diagram 300 that supports computing table-level timestamps using multiple key ranges in accordance with aspects of the present disclosure. The block diagram 300 may implement or may be implemented by aspects of the computing environment 100 or the key range diagram 200. For example, the block diagram 300 may be implemented by a DMS 110, which may be an example of the corresponding device as described with reference to the computing environment 100.

In the following description of the block diagram 300, some operations may occur in a different order than the example order shown and, in some examples, may be performed by one or more different devices other than those described as examples. Some operations also may be omitted from the block diagram 300, and other operations may be added to the block diagram 300. Further, although some operations may be shown to occur at different times for discussion purposes, these operations may actually occur at the same time.

At 305, a DMS 110 (e.g., one or more nodes of a DMS 110, such as a coordinator node) may query a source data storage environment (e.g., a storage node) for a starting point and an ending point of a table. The table may include a set of keys in a keyspan that spans from the starting point to the ending point.

At 310, the DMS 110 may obtain key range and timestamp information. For example, the DMS 110 may receive indications a set of key ranges that includes keys from the set of keys included in the table and indications of a set of timestamps (e.g., checkpoints) associated with each of the set of key ranges. The checkpoints may indicate a latest time at which the associated key range has been updated at a destination data storage environment. The set of key ranges may be stored across a plurality of nodes.

At 315, the DMS 110 may compute a subset of key ranges of the set of key ranges. For example, the DMS 110 may determine a subset of key ranges of the set of key ranges (e.g., and an associated subset of timestamps each associated with one of the subset of key ranges) that include every key of the set of keys included in the keyspan. In some examples, the subset of key ranges of the set of key ranges may include a first key range associated with a temporally latest timestamp of the set of timestamps.

In some examples, the DMS 110 may determine that the subset of key ranges includes every key of the keyspan. For example, at 320, the DMS 110 may generate an array of keys including a starting key and an ending key of every key range of the subset of key ranges. The DMS 110 may sort the array of keys lexicographically (e.g., in an order in which the keys appear in the keyspan). The DMS 110 may compute a set of pseudo key ranges (e.g., p-ranges) using the array of keys. Each p-range of the set of p-ranges may include a key range between consecutive keys in the array of keys. The DMS 110 may determine that every p-range of the set of p-ranges is included in the subset of key ranges, and thus that every key of the keyspan is included in the set of key ranges.

Additionally, or alternatively, at 320, the DMS 110 may generate an array of units. Each unit of the array of units may include a key of the subset of key ranges, a flag indicating whether the key is a starting key or an ending key of the associated key range, and the timestamp of the associated key range. The DMS 110 may sort the array of units based first on the key of the unit, followed by whether the key is a starting key of a key range, and finally based on the timestamp of the unit. The DMS 110 may generate a red-black tree (e.g., an LLRB) of the set of keys. The red-black tree may include a first variable tracking a set of temporally latest (e.g., highest) timestamps of every key of the set of keys and a second variable tracking a current temporally earliest (e.g., lowest) timestamp of the set of temporally latest timestamps.

In some examples (e.g., if the DMS 110 generates an array of units), at 325, the DMS 110 may process the units. For example, the DMS 110 may determine if a key of a first unit is a starting key or an ending key of a key range. If the key is a starting key, the DMS 110 may compare the timestamp of the first unit with a current temporally latest timestamp (e.g., the first variable) associated with the key and may replace the current temporally latest timestamp with the timestamp of the first unit if the timestamp of the first unit is later than the current temporally latest timestamp. The DMS 110 may update the second variable (e.g., if the new current temporally latest timestamp is smaller than the current temporally earliest timestamp of the set of temporally latest timestamps). The DMS 110 may insert the timestamp of the first unit into the red-black tree.

If the key is a starting key, the DMS 110 may compare the timestamp of the first unit with a current temporally latest timestamp (e.g., the first variable) associated with the key and may replace the current temporally latest timestamp with the timestamp of the first unit if the timestamp of the first unit is later than the current temporally latest timestamp. The DMS 110 may update the second variable (e.g., if the new current temporally latest timestamp is smaller than the current temporally earliest timestamp of the set of temporally latest timestamps). The DMS 110 may remove the timestamp of the first unit from the red-black tree. After processing each unit, the DMS 110 may determine that every key of the keyspan is included in the set of key ranges if the red-black tree does not include any holes.

At 330, the DMS 110 may compute a temporally earliest timestamp of the subset of timestamps. For example, the DMS 110 may compute a final value of the second variable after processing each unit of the array of units. Additionally, or alternatively, the DMS 110 may track a temporally earliest timestamp associated with each of the set of p-ranges by determining whether a timestamp of a first p-range is temporally earlier than a timestamp of a subsequent p-range of the set of p-ranges. A timestamp of a p-range may be a temporally latest timestamp of one or more key ranges of the subset of key ranges that fully encompass the p-range.

At 335, the DMS 110 may output the computed temporally earliest timestamp. The temporally earliest timestamp may be indicative of a timestamp of the table as a whole. For example, if the temporally earliest timestamp is older than a threshold amount, the DMS 110 may determine that one or more nodes of the plurality of nodes is backlogged, and thus that the table may not be up-to-date.

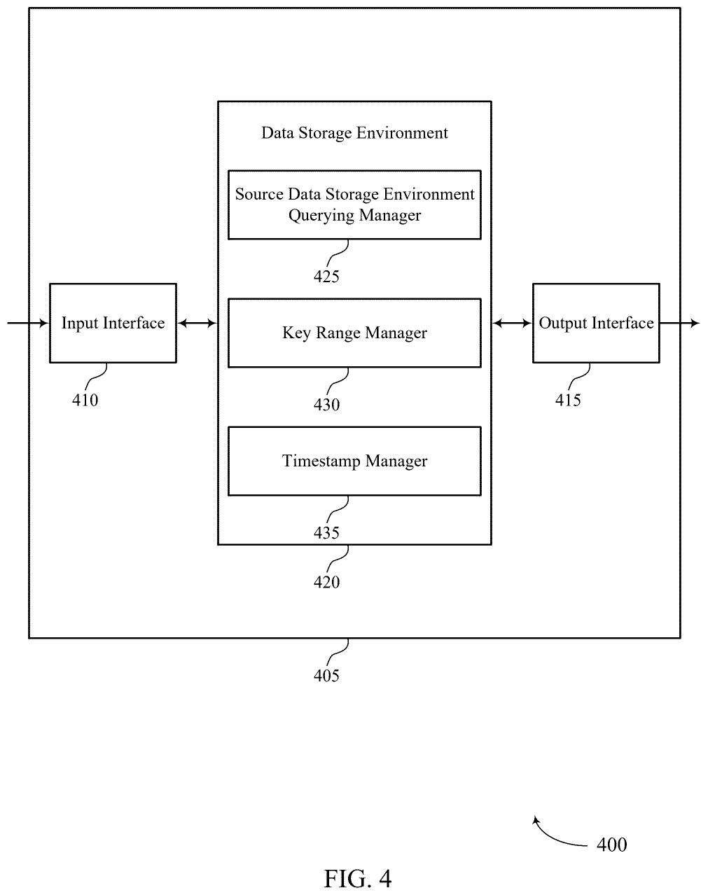

FIG. 4 shows a block diagram 400 of a system 405 that supports computing table-level timestamps using multiple key ranges in accordance with aspects of the present disclosure. In some examples, the system 405 may be an example of aspects of one or more components described with reference to FIG. 1, such as a DMS 110. The system 405 may include an input interface 410, an output interface 415, and a data storage environment 420. The system 405 may also include one or more processors. Each of these components may be in communication with one another (e.g., via one or more buses, communications links, communications interfaces, or any combination thereof).

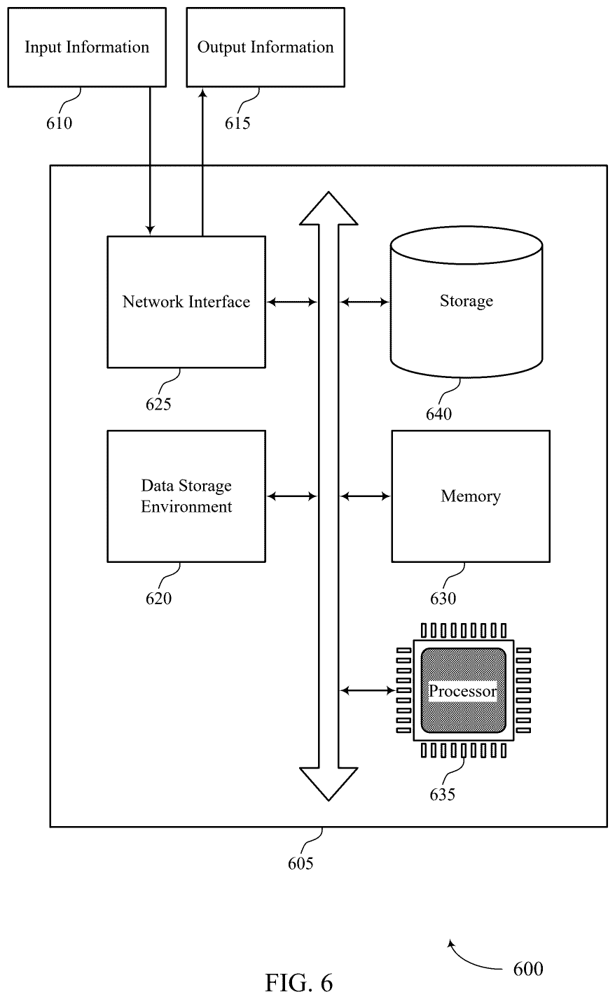

The input interface 410 may manage input signaling for the system 405. For example, the input interface 410 may receive input signaling (e.g., messages, packets, data, instructions, commands, or any other form of encoded information) from other systems or devices. The input interface 410 may send signaling corresponding to (e.g., representative of or otherwise based on) such input signaling to other components of the system 405 for processing. For example, the input interface 410 may transmit such corresponding signaling to the data storage environment 420 to support computing table-level timestamps using multiple key ranges. In some cases, the input interface 410 may be a component of a network interface 625 as described with reference to FIG. 6.

The output interface 415 may manage output signaling for the system 405. For example, the output interface 415 may receive signaling from other components of the system 405, such as the data storage environment 420, and may transmit such output signaling corresponding to (e.g., representative of or otherwise based on) such signaling to other systems or devices. In some cases, the output interface 415 may be a component of a network interface 625 as described with reference to FIG. 6.

For example, the data storage environment 420 may include a source data storage environment querying manager 425, a key range manager 430, a timestamp manager 435, or any combination thereof. In some examples, the data storage environment 420, or various components thereof, may be configured to perform various operations (e.g., receiving, monitoring, transmitting) using or otherwise in cooperation with the input interface 410, the output interface 415, or both. For example, the data storage environment 420 may receive information from the input interface 410, send information to the output interface 415, or be integrated in combination with the input interface 410, the output interface 415, or both to receive information, transmit information, or perform various other operations as described herein.

The source data storage environment querying manager 425 may be configured as or otherwise support a means for querying a source data storage environment for a starting point and an ending point of a table, the table including a set of keys in a keyspan that spans from the starting point to the ending point. The key range manager 430 may be configured as or otherwise support a means for receiving indications of a set of timestamps corresponding to a set of key ranges associated with the table. The key range manager 430 may be configured as or otherwise support a means for computing a subset of key ranges of the set of key ranges, where a timestamp corresponding to a first key range of the subset of key ranges is a temporally latest timestamp of the set of timestamps and where the subset of key ranges includes every key of the set of keys in the keyspan. The timestamp manager 435 may be configured as or otherwise support a means for computing a temporally earliest timestamp of a subset of timestamps associated with the subset of key ranges. The timestamp manager 435 may be configured as or otherwise support a means for outputting an indication of the temporally earliest timestamp of the subset of timestamps.

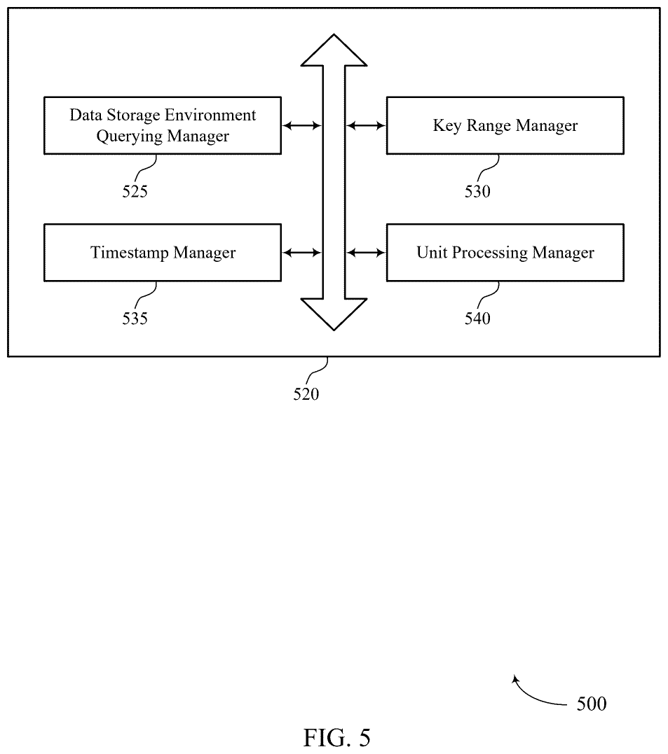

FIG. 5 shows a block diagram 500 of a data storage environment 520 that supports computing table-level timestamps using multiple key ranges in accordance with aspects of the present disclosure. The data storage environment 520 may be an example of aspects of a data storage environment or a data storage environment 420, or both, as described herein. The data storage environment 520, or various components thereof, may be an example of means for performing various aspects of computing table-level timestamps using multiple key ranges as described herein. For example, the data storage environment 520 may include a source data storage environment querying manager 525, a key range manager 530, a timestamp manager 535, a unit processing manager 540, or any combination thereof. Each of these components, or components of subcomponents thereof (e.g., one or more processors, one or more memories), may communicate, directly or indirectly, with one another (e.g., via one or more buses, communications links, communications interfaces, or any combination thereof).

The source data storage environment querying manager 525 may be configured as or otherwise support a means for querying a source data storage environment for a starting point and an ending point of a table, the table including a set of keys in a keyspan that spans from the starting point to the ending point. The key range manager 530 may be configured as or otherwise support a means for receiving indications of a set of timestamps corresponding to a set of key ranges associated with the table. In some examples, the key range manager 530 may be configured as or otherwise support a means for computing a subset of key ranges of the set of key ranges, where a timestamp corresponding to a first key range of the subset of key ranges is a temporally latest timestamp of the set of timestamps and where the subset of key ranges includes every key of the set of keys in the keyspan. The timestamp manager 535 may be configured as or otherwise support a means for computing a temporally earliest timestamp of a subset of timestamps associated with the subset of key ranges. In some examples, the timestamp manager 535 may be configured as or otherwise support a means for outputting an indication of the temporally earliest timestamp of the subset of timestamps.

In some examples, to support computing the subset of key ranges, the key range manager 530 may be configured as or otherwise support a means for determining that the subset of key ranges includes every key of the set of keys in the keyspan.

In some examples, to support determining, the key range manager 530 may be configured as or otherwise support a means for generating an array of keys, the array of keys including a starting key and an ending key of every key range of the subset of key ranges, where the array of keys is sorted lexicographically. In some examples, to support determining, the key range manager 530 may be configured as or otherwise support a means for computing a set of pseudo key ranges, where every pseudo key range of the set of pseudo key ranges includes a key range between consecutive keys in the array of keys. In some examples, to support determining, the key range manager 530 may be configured as or otherwise support a means for determining that every pseudo key range of the set of pseudo key ranges is included in the subset of key ranges.

In some examples, to support computing the temporally earliest timestamp of the subset of timestamps, the timestamp manager 535 may be configured as or otherwise support a means for tracking the temporally earliest timestamp associated with each of the set of pseudo key ranges, where a timestamp associated with a first pseudo key range includes a temporally earliest timestamp of a first timestamp associated with a key range including a starting key of the first pseudo key range and a second timestamp associated with a key range including an ending key of the first pseudo key range, and where tracking the temporally earliest timestamp includes. In some examples, to support computing the temporally earliest timestamp of the subset of timestamps, the timestamp manager 535 may be configured as or otherwise support a means for determining whether the timestamp of the first pseudo key range is temporally earlier than a timestamp of a subsequent pseudo range of the set of pseudo key ranges.

In some examples, the key range manager 530 may be configured as or otherwise support a means for generating an array of units based on the set of key ranges, where every unit of the array of units includes a key of the set of keys, an indication of whether the key is a starting key or an ending key of an associated key range of the subset of key ranges, and the timestamp of the associated key range, and where an order of the array of units is based on a key associated with a respective unit, whether the key is a starting key, and a respective timestamp of every unit of the array of units. In some examples, the unit processing manager 540 may be configured as or otherwise support a means for computing a red-black tree including a first variable tracking a set of current temporally latest timestamps associated with every key of the set of keys and a second variable tracking a temporally earliest timestamp of the set of current temporally latest timestamps.

In some examples, the unit processing manager 540 may be configured as or otherwise support a means for processing each unit of the array of units, where processing a first unit includes. In some examples, the unit processing manager 540 may be configured as or otherwise support a means for determining that the first unit is a starting key. In some examples, the unit processing manager 540 may be configured as or otherwise support a means for comparing the timestamp of the first unit with the first variable. In some examples, the unit processing manager 540 may be configured as or otherwise support a means for updating the second variable. In some examples, the unit processing manager 540 may be configured as or otherwise support a means for inserting the timestamp of the first unit into the red-black tree.

In some examples, the unit processing manager 540 may be configured as or otherwise support a means for processing each unit of the array of units, where processing a first unit includes. In some examples, the unit processing manager 540 may be configured as or otherwise support a means for determining that the first unit is an ending key. In some examples, the unit processing manager 540 may be configured as or otherwise support a means for comparing the timestamp of the first unit with the first variable. In some examples, the unit processing manager 540 may be configured as or otherwise support a means for updating the second variable. In some examples, the unit processing manager 540 may be configured as or otherwise support a means for removing the timestamp of the first unit into the red-black tree.

In some examples, the set of key ranges are stored across a set of multiple nodes.

FIG. 6 shows a block diagram 600 of a system 605 that supports computing table-level timestamps using multiple key ranges in accordance with aspects of the present disclosure. The system 605 may be an example of or include components of a system 405 as described herein. The system 605 may include components for data management, including components such as a data storage environment 620, an input information 610, an output information 615, a network interface 625, at least one memory 630, at least one processor 635, and a storage 640. These components may be in electronic communication or otherwise coupled with each other (e.g., operatively, communicatively, functionally, electronically, electrically; via one or more buses, communications links, communications interfaces, or any combination thereof). Additionally, the components of the system 605 may include corresponding physical components or may be implemented as corresponding virtual components (e.g., components of one or more virtual machines). In some examples, the system 605 may be an example of aspects of one or more components described with reference to FIG. 1, such as a DMS 110.

The network interface 625 may enable the system 605 to exchange information (e.g., input information 610, output information 615, or both) with other systems or devices (not shown). For example, the network interface 625 may enable the system 605 to connect to a network (e.g., a network 120 as described herein). The network interface 625 may include one or more wireless network interfaces, one or more wired network interfaces, or any combination thereof. In some examples, the network interface 625 may be an example of may be an example of aspects of one or more components described with reference to FIG. 1, such as one or more network interfaces 165.

Memory 630 may include RAM, ROM, or both. The memory 630 may store computer-readable, computer-executable software including instructions that, when executed, cause the processor 635 to perform various functions described herein. In some cases, the memory 630 may contain, among other things, a basic input/output system (BIOS), which may control basic hardware or software operation such as the interaction with peripheral components or devices. In some cases, the memory 630 may be an example of aspects of one or more components described with reference to FIG. 1, such as one or more memories 175.

The processor 635 may include an intelligent hardware device, (e.g., a general-purpose processor, a DSP, a CPU, a microcontroller, an ASIC, a field programmable gate array (FPGA), a programmable logic device, a discrete gate or transistor logic component, a discrete hardware component, or any combination thereof). The processor 635 may be configured to execute computer-readable instructions stored in a memory 630 to perform various functions (e.g., functions or tasks supporting computing table-level timestamps using multiple key ranges). Though a single processor 635 is depicted in the example of FIG. 6, it is to be understood that the system 605 may include any quantity of one or more of processors 635 and that a group of processors 635 may collectively perform one or more functions ascribed herein to a processor, such as the processor 635. In some cases, the processor 635 may be an example of aspects of one or more components described with reference to FIG. 1, such as one or more processors 170.

Storage 640 may be configured to store data that is generated, processed, stored, or otherwise used by the system 605. In some cases, the storage 640 may include one or more HDDs, one or more SDDs, or both. In some examples, the storage 640 may be an example of a single database, a distributed database, multiple distributed databases, a data store, a data lake, or an emergency backup database. In some examples, the storage 640 may be an example of one or more components described with reference to FIG. 1, such as one or more network disks 180.

For example, the data storage environment 620 may be configured as or otherwise support a means for querying a source data storage environment for a starting point and an ending point of a table, the table including a set of keys in a keyspan that spans from the starting point to the ending point. The data storage environment 620 may be configured as or otherwise support a means for receiving indications of a set of timestamps corresponding to a set of key ranges associated with the table. The data storage environment 620 may be configured as or otherwise support a means for computing a subset of key ranges of the set of key ranges, where a timestamp corresponding to a first key range of the subset of key ranges is a temporally latest timestamp of the set of timestamps and where the subset of key ranges includes every key of the set of keys in the keyspan. The data storage environment 620 may be configured as or otherwise support a means for computing a temporally earliest timestamp of a subset of timestamps associated with the subset of key ranges. The data storage environment 620 may be configured as or otherwise support a means for outputting an indication of the temporally earliest timestamp of the subset of timestamps.

By including or configuring the data storage environment 620 in accordance with examples as described herein, the system 605 may support techniques for computing table-level timestamps using multiple key ranges, which may provide one or more benefits such as, for example, improved reliability, reduced latency, improved user experience, and improved scalability, among other possibilities.

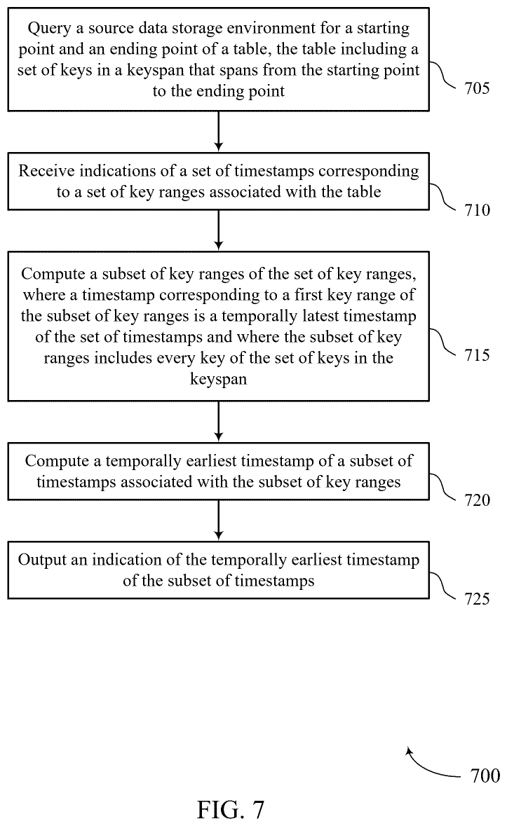

FIG. 7 shows a flowchart illustrating a method 700 that supports computing table-level timestamps using multiple key ranges in accordance with aspects of the present disclosure. The operations of the method 700 may be implemented by a DMS or its components as described herein. For example, the operations of the method 700 may be performed by a DMS as described with reference to FIGS. 1 through 6. In some examples, a DMS may execute a set of instructions to control the functional elements of the DMS to perform the described functions. Additionally, or alternatively, the DMS may perform aspects of the described functions using special-purpose hardware.

At 705, the method may include querying a source data storage environment for a starting point and an ending point of a table, the table including a set of keys in a keyspan that spans from the starting point to the ending point. The operations of 705 may be performed in accordance with examples as disclosed herein. In some examples, aspects of the operations of 705 may be performed by a source data storage environment querying manager 525 as described with reference to FIG. 5.

At 710, the method may include receiving indications of a set of timestamps corresponding to a set of key ranges associated with the table. The operations of 710 may be performed in accordance with examples as disclosed herein. In some examples, aspects of the operations of 710 may be performed by a key range manager 530 as described with reference to FIG. 5.

At 715, the method may include computing a subset of key ranges of the set of key ranges, where a timestamp corresponding to a first key range of the subset of key ranges is a temporally latest timestamp of the set of timestamps and where the subset of key ranges includes every key of the set of keys in the keyspan. The operations of 715 may be performed in accordance with examples as disclosed herein. In some examples, aspects of the operations of 715 may be performed by a key range manager 530 as described with reference to FIG. 5.

At 720, the method may include computing a temporally earliest timestamp of a subset of timestamps associated with the subset of key ranges. The operations of 720 may be performed in accordance with examples as disclosed herein. In some examples, aspects of the operations of 720 may be performed by a timestamp manager 535 as described with reference to FIG. 5.

At 725, the method may include outputting an indication of the temporally earliest timestamp of the subset of timestamps. The operations of 725 may be performed in accordance with examples as disclosed herein. In some examples, aspects of the operations of 725 may be performed by a timestamp manager 535 as described with reference to FIG. 5.

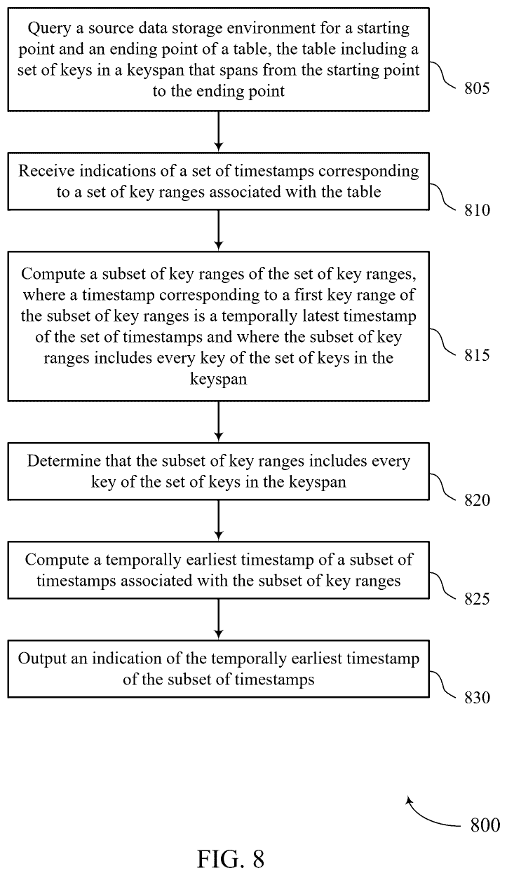

FIG. 8 shows a flowchart illustrating a method 800 that supports computing table-level timestamps using multiple key ranges in accordance with aspects of the present disclosure. The operations of the method 800 may be implemented by a DMS or its components as described herein. For example, the operations of the method 800 may be performed by a DMS as described with reference to FIGS. 1 through 6. In some examples, a DMS may execute a set of instructions to control the functional elements of the DMS to perform the described functions. Additionally, or alternatively, the DMS may perform aspects of the described functions using special-purpose hardware.

At 805, the method may include querying a source data storage environment for a starting point and an ending point of a table, the table including a set of keys in a keyspan that spans from the starting point to the ending point. The operations of 805 may be performed in accordance with examples as disclosed herein. In some examples, aspects of the operations of 805 may be performed by a source data storage environment querying manager 525 as described with reference to FIG. 5.

At 810, the method may include receiving indications of a set of timestamps corresponding to a set of key ranges associated with the table. The operations of 810 may be performed in accordance with examples as disclosed herein. In some examples, aspects of the operations of 810 may be performed by a key range manager 530 as described with reference to FIG. 5.

At 815, the method may include computing a subset of key ranges of the set of key ranges, where a timestamp corresponding to a first key range of the subset of key ranges is a temporally latest timestamp of the set of timestamps and where the subset of key ranges includes every key of the set of keys in the keyspan. The operations of 815 may be performed in accordance with examples as disclosed herein. In some examples, aspects of the operations of 815 may be performed by a key range manager 530 as described with reference to FIG. 5.

At 820, the method may include determining that the subset of key ranges includes every key of the set of keys in the keyspan. The operations of 820 may be performed in accordance with examples as disclosed herein. In some examples, aspects of the operations of 820 may be performed by a key range manager 530 as described with reference to FIG. 5.

At 825, the method may include computing a temporally earliest timestamp of a subset of timestamps associated with the subset of key ranges. The operations of 825 may be performed in accordance with examples as disclosed herein. In some examples, aspects of the operations of 825 may be performed by a timestamp manager 535 as described with reference to FIG. 5.

At 830, the method may include outputting an indication of the temporally earliest timestamp of the subset of timestamps. The operations of 830 may be performed in accordance with examples as disclosed herein. In some examples, aspects of the operations of 830 may be performed by a timestamp manager 535 as described with reference to FIG. 5.

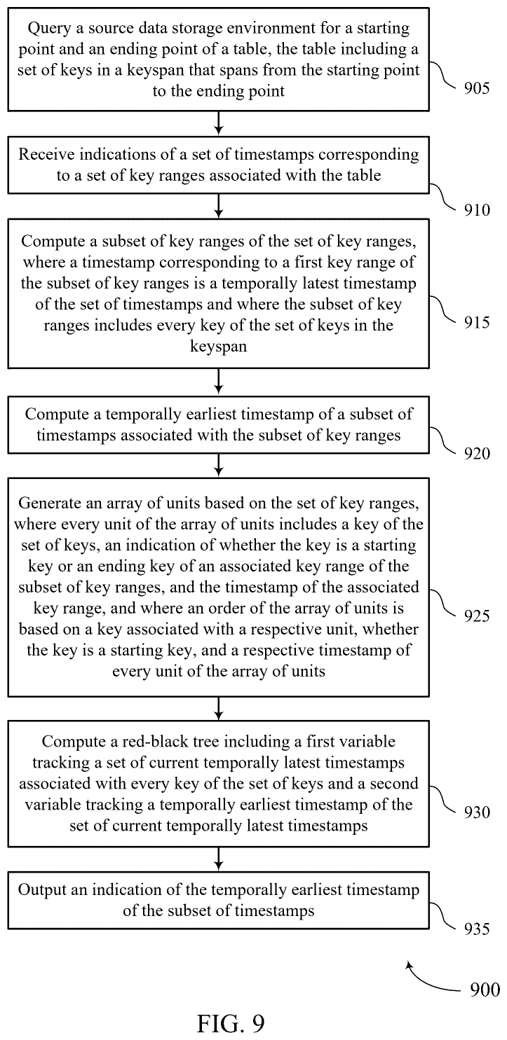

FIG. 9 shows a flowchart illustrating a method 900 that supports computing table-level timestamps using multiple key ranges in accordance with aspects of the present disclosure. The operations of the method 900 may be implemented by a DMS or its components as described herein. For example, the operations of the method 900 may be performed by a DMS as described with reference to FIGS. 1 through 6. In some examples, a DMS may execute a set of instructions to control the functional elements of the DMS to perform the described functions. Additionally, or alternatively, the DMS may perform aspects of the described functions using special-purpose hardware.

At 905, the method may include querying a source data storage environment for a starting point and an ending point of a table, the table including a set of keys in a keyspan that spans from the starting point to the ending point. The operations of 905 may be performed in accordance with examples as disclosed herein. In some examples, aspects of the operations of 905 may be performed by a source data storage environment querying manager 525 as described with reference to FIG. 5.

At 910, the method may include receiving indications of a set of timestamps corresponding to a set of key ranges associated with the table. The operations of 910 may be performed in accordance with examples as disclosed herein. In some examples, aspects of the operations of 910 may be performed by a key range manager 530 as described with reference to FIG. 5.

At 915, the method may include computing a subset of key ranges of the set of key ranges, where a timestamp corresponding to a first key range of the subset of key ranges is a temporally latest timestamp of the set of timestamps and where the subset of key ranges includes every key of the set of keys in the keyspan. The operations of 915 may be performed in accordance with examples as disclosed herein. In some examples, aspects of the operations of 915 may be performed by a key range manager 530 as described with reference to FIG. 5.

At 920, the method may include computing a temporally earliest timestamp of a subset of timestamps associated with the subset of key ranges. The operations of 920 may be performed in accordance with examples as disclosed herein. In some examples, aspects of the operations of 920 may be performed by a timestamp manager 535 as described with reference to FIG. 5.

At 925, the method may include generating an array of units based on the set of key ranges, where every unit of the array of units includes a key of the set of keys, an indication of whether the key is a starting key or an ending key of an associated key range of the subset of key ranges, and the timestamp of the associated key range, and where an order of the array of units is based on a key associated with a respective unit, whether the key is a starting key, and a respective timestamp of every unit of the array of units. The operations of 925 may be performed in accordance with examples as disclosed herein. In some examples, aspects of the operations of 925 may be performed by a key range manager 530 as described with reference to FIG. 5.

At 930, the method may include computing a red-black tree including a first variable tracking a set of current temporally latest timestamps associated with every key of the set of keys and a second variable tracking a temporally earliest timestamp of the set of current temporally latest timestamps. The operations of 930 may be performed in accordance with examples as disclosed herein. In some examples, aspects of the operations of 930 may be performed by a unit processing manager 540 as described with reference to FIG. 5.

At 935, the method may include outputting an indication of the temporally earliest timestamp of the subset of timestamps. The operations of 935 may be performed in accordance with examples as disclosed herein. In some examples, aspects of the operations of 935 may be performed by a timestamp manager 535 as described with reference to FIG. 5.

A method by an apparatus is described. The method may include querying a source data storage environment for a starting point and an ending point of a table, the table including a set of keys in a keyspan that spans from the starting point to the ending point, receiving indications of a set of timestamps corresponding to a set of key ranges associated with the table, computing a subset of key ranges of the set of key ranges, where a timestamp corresponding to a first key range of the subset of key ranges is a temporally latest timestamp of the set of timestamps and where the subset of key ranges includes every key of the set of keys in the keyspan, computing a temporally earliest timestamp of a subset of timestamps associated with the subset of key ranges, and outputting an indication of the temporally earliest timestamp of the subset of timestamps.

An apparatus is described. The apparatus may include one or more memories storing processor executable code, and one or more processors coupled with the one or more memories. The one or more processors may individually or collectively be operable to execute the code to cause the apparatus to query a source data storage environment for a starting point and an ending point of a table, the table including a set of keys in a keyspan that spans from the starting point to the ending point, receive indications of a set of timestamps corresponding to a set of key ranges associated with the table, compute a subset of key ranges of the set of key ranges, where a timestamp corresponding to a first key range of the subset of key ranges is a temporally latest timestamp of the set of timestamps and where the subset of key ranges includes every key of the set of keys in the keyspan, compute a temporally earliest timestamp of a subset of timestamps associated with the subset of key ranges, and output an indication of the temporally earliest timestamp of the subset of timestamps.

Another apparatus is described. The apparatus may include means for querying a source data storage environment for a starting point and an ending point of a table, the table including a set of keys in a keyspan that spans from the starting point to the ending point, means for receiving indications of a set of timestamps corresponding to a set of key ranges associated with the table, means for computing a subset of key ranges of the set of key ranges, where a timestamp corresponding to a first key range of the subset of key ranges is a temporally latest timestamp of the set of timestamps and where the subset of key ranges includes every key of the set of keys in the keyspan, means for computing a temporally earliest timestamp of a subset of timestamps associated with the subset of key ranges, and means for outputting an indication of the temporally earliest timestamp of the subset of timestamps.

A non-transitory computer-readable medium storing code is described. The code may include instructions executable by one or more processors to query a source data storage environment for a starting point and an ending point of a table, the table including a set of keys in a keyspan that spans from the starting point to the ending point, receive indications of a set of timestamps corresponding to a set of key ranges associated with the table, compute a subset of key ranges of the set of key ranges, where a timestamp corresponding to a first key range of the subset of key ranges is a temporally latest timestamp of the set of timestamps and where the subset of key ranges includes every key of the set of keys in the keyspan, compute a temporally earliest timestamp of a subset of timestamps associated with the subset of key ranges, and output an indication of the temporally earliest timestamp of the subset of timestamps.

In some examples of the method, apparatus, and non-transitory computer-readable medium described herein, computing the subset of key ranges may include operations, features, means, or instructions for determining that the subset of key ranges includes every key of the set of keys in the keyspan.

In some examples of the method, apparatus, and non-transitory computer-readable medium described herein, the determining may include operations, features, means, or instructions for generating an array of keys, the array of keys including a starting key and an ending key of every key range of the subset of key ranges, where the array of keys may be sorted lexicographically, computing a set of pseudo key ranges, where every pseudo key range of the set of pseudo key ranges includes a key range between consecutive keys in the array of keys, and determining that every pseudo key range of the set of pseudo key ranges may be included in the subset of key ranges.

In some examples of the method, apparatus, and non-transitory computer-readable medium described herein, computing the temporally earliest timestamp of the subset of timestamps may include operations, features, means, or instructions for tracking the temporally earliest timestamp associated with each of the set of pseudo key ranges, where a timestamp associated with a first pseudo key range includes a temporally earliest timestamp of a first timestamp associated with a key range including a starting key of the first pseudo key range and a second timestamp associated with a key range including an ending key of the first pseudo key range, and where tracking the temporally earliest timestamp includes and determining whether the timestamp of the first pseudo key range may be temporally earlier than a timestamp of a subsequent pseudo range of the set of pseudo key ranges.

Some examples of the method, apparatus, and non-transitory computer-readable medium described herein may further include operations, features, means, or instructions for generating an array of units based on the set of key ranges, where every unit of the array of units includes a key of the set of keys, an indication of whether the key may be a starting key or an ending key of an associated key range of the subset of key ranges, and the timestamp of the associated key range, and where an order of the array of units may be based on a key associated with a respective unit, whether the key may be a starting key, and a respective timestamp of every unit of the array of units and computing a red-black tree including a first variable tracking a set of current temporally latest timestamps associated with every key of the set of keys and a second variable tracking a temporally earliest timestamp of the set of current temporally latest timestamps.

Some examples of the method, apparatus, and non-transitory computer-readable medium described herein may further include operations, features, means, or instructions for processing each unit of the array of units, where processing a first unit includes, determining that the first unit may be a starting key, comparing the timestamp of the first unit with the first variable, updating the second variable, and inserting the timestamp of the first unit into the red-black tree.

Some examples of the method, apparatus, and non-transitory computer-readable medium described herein may further include operations, features, means, or instructions for processing each unit of the array of units, where processing a first unit includes, determining that the first unit may be an ending key, comparing the timestamp of the first unit with the first variable, updating the second variable, and removing the timestamp of the first unit into the red-black tree.

In some examples of the method, apparatus, and non-transitory computer-readable medium described herein, the set of key ranges may be stored across a set of multiple nodes.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Further, a system as used herein may be a collection of devices, a single device, or aspects within a single device.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, EEPROM) compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, “a component” having characteristics or performing functions may refer to “at least one of one or more components” having a particular characteristic or performing a particular function. Subsequent reference to a component introduced with the article “a” using the terms “the” or “said” refers to any or all of the one or more components. For example, a component introduced with the article “a” shall be understood to mean “one or more components,” and referring to “the component” subsequently in the claims shall be understood to be equivalent to referring to “at least one of the one or more components.”

Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method, comprising:
querying a source data storage environment for a starting point and an ending point of a table, the table comprising a set of keys in a keyspan that spans from the starting point to the ending point;
receiving indications of a set of timestamps corresponding to a set of key ranges associated with the table;
computing a subset of key ranges of the set of key ranges, wherein a timestamp corresponding to a first key range of the subset of key ranges is a temporally latest timestamp of the set of timestamps and wherein the subset of key ranges includes every key of the set of keys in the keyspan;
computing a temporally earliest timestamp of a subset of timestamps associated with the subset of key ranges; and
outputting an indication of the temporally earliest timestamp of the subset of timestamps.

2. The method of claim 1, wherein computing the subset of key ranges comprises:
determining that the subset of key ranges includes every key of the set of keys in the keyspan.

3. The method of claim 2, wherein the determining comprises:
generating an array of keys, the array of keys comprising a starting key and an ending key of every key range of the subset of key ranges, wherein the array of keys is sorted lexicographically;
computing a set of pseudo key ranges, wherein every pseudo key range of the set of pseudo key ranges comprises a key range between consecutive keys in the array of keys; and
determining that every pseudo key range of the set of pseudo key ranges is included in the subset of key ranges.

4. The method of claim 3, wherein computing the temporally earliest timestamp of the subset of timestamps comprises:
tracking the temporally earliest timestamp associated with each of the set of pseudo key ranges, wherein a timestamp associated with a first pseudo key range comprises a temporally earliest timestamp of a first timestamp associated with a key range including a starting key of the first pseudo key range and a second timestamp associated with a key range including an ending key of the first pseudo key range, and wherein tracking the temporally earliest timestamp comprises:
determining whether the timestamp of the first pseudo key range is temporally earlier than a timestamp of a subsequent pseudo range of the set of pseudo key ranges.

5. The method of claim 1, further comprising:
generating an array of units based at least in part on the set of key ranges, wherein every unit of the array of units comprises a key of the set of keys, an indication of whether the key is a starting key or an ending key of an associated key range of the subset of key ranges, and the timestamp of the associated key range, and wherein an order of the array of units is based at least in part on a key associated with a respective unit, whether the key is a starting key, and a respective timestamp of every unit of the array of units; and
computing a red-black tree including a first variable tracking a set of current temporally latest timestamps associated with every key of the set of keys and a second variable tracking a temporally earliest timestamp of the set of current temporally latest timestamps.

6. The method of claim 5, further comprising:
processing each unit of the array of units, wherein processing a first unit comprises:
determining that the first unit is a starting key;
comparing the timestamp of the first unit with the first variable;
updating the second variable; and
inserting the timestamp of the first unit into the red-black tree.

7. The method of claim 5, further comprising:
processing each unit of the array of units, wherein processing a first unit comprises:
determining that the first unit is an ending key;
comparing the timestamp of the first unit with the first variable;
updating the second variable; and
removing the timestamp of the first unit into the red-black tree.

8. The method of claim 1, wherein the set of key ranges are stored across a plurality of nodes.

9. An apparatus, comprising:
one or more memories storing processor-executable code; and
one or more processors coupled with the one or more memories and individually or collectively operable to execute the code to cause the apparatus to:
query a source data storage environment for a starting point and an ending point of a table, the table comprising a set of keys in a keyspan that spans from the starting point to the ending point;
receive indications of a set of timestamps corresponding to a set of key ranges associated with the table;
compute a subset of key ranges of the set of key ranges, wherein a timestamp corresponding to a first key range of the subset of key ranges is a temporally latest timestamp of the set of timestamps and wherein the subset of key ranges includes every key of the set of keys in the keyspan;
compute a temporally earliest timestamp of a subset of timestamps associated with the subset of key ranges; and
output an indication of the temporally earliest timestamp of the subset of timestamps.

10. The apparatus of claim 9, wherein, to compute the subset of key ranges, the one or more processors are individually or collectively operable to execute the code to cause the apparatus to:
determine that the subset of key ranges includes every key of the set of keys in the keyspan.

11. The apparatus of claim 10, wherein, to determine, the one or more processors are individually or collectively operable to execute the code to cause the apparatus to:
generate an array of keys, the array of keys comprising a starting key and an ending key of every key range of the subset of key ranges, wherein the array of keys is sorted lexicographically;
compute a set of pseudo key ranges, wherein every pseudo key range of the set of pseudo key ranges comprises a key range between consecutive keys in the array of keys; and
determine that every pseudo key range of the set of pseudo key ranges is included in the subset of key ranges.

12. The apparatus of claim 11, wherein, to compute the temporally earliest timestamp of the subset of timestamps, the one or more processors are individually or collectively operable to execute the code to cause the apparatus to:
track the temporally earliest timestamp associated with each of the set of pseudo key ranges, wherein a timestamp associated with a first pseudo key range comprises a temporally earliest timestamp of a first timestamp associated with a key range including a starting key of the first pseudo key range and a second timestamp associated with a key range including an ending key of the first pseudo key range, and wherein tracking the temporally earliest timestamp comprises:
determining whether the timestamp of the first pseudo key range is temporally earlier than a timestamp of a subsequent pseudo range of the set of pseudo key ranges.

13. The apparatus of claim 9, wherein the one or more processors are individually or collectively further operable to execute the code to cause the apparatus to:
generate an array of units based at least in part on the set of key ranges, wherein every unit of the array of units comprises a key of the set of keys, an indication of whether the key is a starting key or an ending key of an associated key range of the subset of key ranges, and the timestamp of the associated key range, and wherein an order of the array of units is based at least in part on a key associated with a respective unit, whether the key is a starting key, and a respective timestamp of every unit of the array of units; and
compute a red-black tree including a first variable tracking a set of current temporally latest timestamps associated with every key of the set of keys and a second variable tracking a temporally earliest timestamp of the set of current temporally latest timestamps.

14. The apparatus of claim 13, wherein the one or more processors are individually or collectively further operable to execute the code to cause the apparatus to:
process each unit of the array of units, wherein processing a first unit comprises:
determine that the first unit is a starting key;
compare the timestamp of the first unit with the first variable;
update the second variable; and
insert the timestamp of the first unit into the red-black tree.

15. The apparatus of claim 13, wherein the one or more processors are individually or collectively further operable to execute the code to cause the apparatus to:
process each unit of the array of units, wherein processing a first unit comprises:
determine that the first unit is an ending key;
compare the timestamp of the first unit with the first variable;
update the second variable; and
remove the timestamp of the first unit into the red-black tree.

16. The apparatus of claim 9, wherein the set of key ranges are stored across a plurality of nodes.

17. A non-transitory computer-readable medium storing code, the code comprising instructions executable by one or more processors to:
query a source data storage environment for a starting point and an ending point of a table, the table comprising a set of keys in a keyspan that spans from the starting point to the ending point;
receive indications of a set of timestamps corresponding to a set of key ranges associated with the table;
compute a subset of key ranges of the set of key ranges, wherein a timestamp corresponding to a first key range of the subset of key ranges is a temporally latest timestamp of the set of timestamps and wherein the subset of key ranges includes every key of the set of keys in the keyspan;
compute a temporally earliest timestamp of a subset of timestamps associated with the subset of key ranges; and
output an indication of the temporally earliest timestamp of the subset of timestamps.

18. The non-transitory computer-readable medium of claim 17, wherein, to compute the subset of key ranges, the instructions are further executable by the one or more processors to:
determine that the subset of key ranges includes every key of the set of keys in the keyspan.

19. The non-transitory computer-readable medium of claim 18, wherein, to determine that the subset of key ranges includes every key of the set of keys in the keyspan, the instructions are further executable by the one or more processors to:
generate an array of keys, the array of keys comprising a starting key and an ending key of every key range of the subset of key ranges, wherein the array of keys is sorted lexicographically;
compute a set of pseudo key ranges, wherein every pseudo key range of the set of pseudo key ranges comprises a key range between consecutive keys in the array of keys; and
determine that every pseudo key range of the set of pseudo key ranges is included in the subset of key ranges.

20. The non-transitory computer-readable medium of claim 19, wherein, to compute the temporally earliest timestamp of the subset of timestamps, the instructions are further executable by the one or more processors to:
track the temporally earliest timestamp associated with each of the set of pseudo key ranges, wherein a timestamp associated with a first pseudo key range comprises a temporally earliest timestamp of a first timestamp associated with a key range including a starting key of the first pseudo key range and a second timestamp associated with a key range including an ending key of the first pseudo key range, and wherein tracking the temporally earliest timestamp comprises:
determining whether the timestamp of the first pseudo key range is temporally earlier than a timestamp of a subsequent pseudo range of the set of pseudo key ranges.
